(19) United States
(12) Patent Application Publication
(10) Pub. No.: US 2006/0273489 A1
(43) Pub. Date: Dec. 7, 2006

(54) Slide-ejector actuator

(76) Inventor: Wayne A. Shakal, Taylors Falls, MN (US)

Correspondence Address: INTELLECTUAL PROPERTY GROUP;FREDRIKSON & BYRON, P.A., 200 SOUTH SIXTH STREET, SUITE 4000, MINNEAPOLIS, MN, 55402, US

(21) Appl. No.: 11/432,290

(22) Filed: May 11, 2006

Related U.S. Application Data
(60) Provisional application No. 60/680,089, filed on May 12, 2005.

(51) Int. Cl. B29C 45/00

(52) U.S. Cl. 264/297.2; 425/556; 264/328.1; 264/334

(57) ABSTRACT

Some embodiments of the present invention involve a slide-eject mechanism. The slide-eject mechanism can withdraw a slide from a mold cavity. The slide-eject mechanism can eject a part from the mold cavity in response to removing the slide from the mold cavity. In some embodiments, parts can be ejected from an injection molding mold without using the injection molding machine's ejection mechanism. Some embodiments can make use of the mechanical energy of slide blocks to eject finished parts. In some embodiments, ejection can occur while the injection molding mold is in the closed position, which can improve injection molding throughput.

### CROSS-REFERENCE TO RELATED APPLICATION

This application claims priority under 35 U.S.C. §119(e) to U.S. provisional application 60/680,089, filed May 12, 2005, which is hereby incorporated by reference in relevant part.

### TECHNICAL FIELD

This document relates to a variety of applications involving injection molding.

### BACKGROUND

Injection molding is a common process for manufacturing plastic parts. Manufacturers can produce large quantities of parts having complex geometries in a single production step. In many instances, finishing operations are not be necessary. Thermosets and/or thermoplastics can be used.

In injection molding, molten plastic is injected at high pressure into a mold, which is the inverse of the desired shape of the articles to be molded. The mold may be made by a moldmaker (or toolmaker) from metal (e.g., steel or aluminum) and precision-machined to form the features of the desired parts. After the plastic is injected, it cools until hardened, thereby forming the desired molded parts. The parts can then be ejected, and, commonly, the process is repeated several times.

Parts produced by injection molding pervade modern life. Examples include automotive parts, appliances, toys, components used in medical devices, consumer electronic goods, household goods, and communication and industrial equipment.

Some injection molding applications employ multiple processing stations. Examples of such applications include in-mold assembly operations, insert loading, over-molding, part transfer, providing additional cooling time for certain parts, in-mold decorating, in-mold labeling, and in-mold assembly stations. Increasing the speed and/or accuracy associated with such applications can provide substantial benefits.

### SUMMARY

In one aspect, the invention involves an injection molding mold for use in injection molding applications. The injection molding mold can include first and second mold plates. The first mold plate can be configured to be connected to a stationary platen of an injection molding machine. The second mold plate can be configured to be connected to a movable platen of an injection molding machine. The injection molding mold can include a mold cavity that includes a slide. The injection molding mold can include a slide-eject mechanism, which can be configured to eject a finished part from the mold cavity by removing the slide from the mold cavity. The injection molding mold can include an actuator coupled to one of the mold plates. The actuator can be configured to actuate the slide-eject mechanism.

In a second aspect, the invention involves an injection molding mold for use in injection molding applications. The injection molding mold can include first and second mold plates. The first mold plate can be configured to be connected to a stationary platen of an injection molding machine. The second mold plate can be configured to be connected to a movable platen of an injection molding machine. The injection molding mold can include a rotatable turret having a mold cavity that comprises a slide. The injection molding mold can include slide-eject means for removing the slide from the mold cavity or ejecting a finished part from the mold cavity. The injection molding mold can include an actuator coupled to one of the mold plates. The actuator can be configured to actuate the slide-eject means. The rotatable turret can be rotatable relative to the actuator.

In a third aspect, the invention involves an injection molding method. The injection molding method can include injecting a first quantity of resin into a first mold cavity. The first mold cavity can include a first slide. The injection molding method can include allowing the first quantity of resin to cool, thereby creating a first finished part. The injection molding method can include removing the first slide from the first mold cavity. The injection molding method can include ejecting the first finished part as a result of removing the first slide from the first mold cavity.

In a fourth aspect, the invention involves a slide-eject mechanism. The slide-eject mechanism can include means for withdrawing a slide from a mold cavity. The slide-eject mechanism can include means for ejecting a part from the mold cavity in response to removing the slide from the mold cavity.

Embodiments can include one or more of the following features. The slide-eject mechanism can include a slide driver. The actuator can be configured to move the slide driver in a first direction. The slide driver can be configured to remove the slide from the mold cavity by moving the slide in a second direction that differs from the first direction. The second direction is substantially perpendicular to the first direction. The slide-eject mechanism can include a rocker and ejection equipment. The rocker can be configured to trigger the ejection equipment in response to being contacted by the slide. The injection molding mold can include a rotatable turret. The rotatable turret can be positioned between, and coupled to, the first and second mold plates. A portion of the mold cavity can be coupled to the rotatable turret. The rotatable turret can include an injection processing station on a first turret face and an ejection processing station on a second turret face. The rotatable turret can be configured to allow a first part to be formed at the injection processing station and ejected at the ejection processing station. The rotatable turret can be rotatable relative to the actuator. In some embodiments, the rotatable turret can have exactly two turret faces. The slide-eject mechanism can be configured to eject a finished part when the injection molding mold is in a closed position.

In some embodiments, the slide-eject mechanism can include several features. The slide driver can be coupled to one of the mold plates and can be movable by the actuator in a first direction. The slide-eject mechanism can include a slide engagement block coupled to the one of the mold plates. The slide engagement block being can be movable by the slide driver in a second direction that differs from the first direction. The slide engagement block can be configured to engage the slide and move the slide in the second direction. The slide-eject mechanism can include ejection equipment coupled to the rotatable turret. The ejection equipment can be configured to eject the finished part from the mold cavity. The slide-eject mechanism can include a rocker coupled to the rotatable turret. The rocker can be configured to make use of energy from movement of the slide in the second direction by triggering the ejection equipment to eject the finished part from the mold cavity.

In some embodiments, an injection molding method can include several steps. Some embodiments can include moving the first quantity of resin and the first slide from an injection processing station to an ejection processing station. Some embodiments can include injecting a second quantity of resin into a second mold cavity that comprises a second slide at the injection processing station while the first quantity of resin is cooling at the ejection processing station. Some embodiments can include performing an injection molding process on the first quantity of resin. The injection molding process can be selected from a group consisting of: overmolding, labeling, decorating, transferring, and combinations thereof. In some embodiments, removing the first slide from the first mold cavity can include actuating a slide driver to move in a first direction, thereby causing the first slide to move out of the first mold cavity in a second direction that differs from the first direction. In some embodiments, ejecting the first finished part can include causing a rocker to trigger ejection equipment in response to being contacted by the first slide.

Certain embodiments may have one or more of the following advantages. Some embodiments substantially improve injection molding throughput, which is an important factor in injection molding. In such embodiments, performing processes in one part of an injection molding mold while molded parts cool at a different part of the injection molding mold can substantially improve injection molding throughput. This is especially so for parts that involve significant cooling for part features that are formed with slide blocks due to undercuts in their part geometry. Some embodiments improve efficiency in that they do not require a separate energy input to eject finished parts. In some embodiments, parts can be ejected without using the injection molding machine's ejection mechanism. Some embodiments can make use of the mechanical energy of slide blocks to eject finished parts. In some embodiments, the opening of slides causes ejection of parts. Some embodiments avoid difficulties associated with having the actuator that controls the slide blocks rotate with a rotatable turret. In such embodiments, the actuator that controls the slide blocks can be separate from, and need not rotate with, the rotatable turret. In some embodiments, ejection can occur while the injection molding mold is in the closed position, which can improve injection molding throughput.

### BRIEF DESCRIPTION OF THE DRAWINGS

FIGS. 1-2 are perspective views of an exemplary injection molding mold in a closed position.

FIG. 3 is a perspective view of the injection molding mold of FIGS. 1-2 in an open position.

FIG. 4 is a perspective view of the injection molding mold of FIGS. 1-3 in an open position with a rotatable turret in the process of rotating.

FIG. 5 is a perspective view of the injection molding mold of FIGS. 1-4 in an open position with the rotatable turret having been rotated 1800.

FIG. 6 is a perspective view of the injection molding mold of FIGS. 1-5 in a closed position with the rotatable turret having been rotated 1800.

FIG. 7 is a view of cross-section Q-Q of the injection molding mold of FIGS. 1-6 in a closed position.

FIG. 8 is a view of the same cross-section as FIG. 7 with the injection molding mold in an open position and the rotatable turret in the process of rotating.

FIG. 9 is a view of the same cross-section as FIGS. 7-8 with the injection molding mold in a closed position and the rotatable turret having been rotated 180° from the orientation in FIG. 7.

FIG. 10 is a view of the same cross-section as FIGS. 7-9 with the injection molding mold in the process of ejecting finished parts.

FIG. 11 is a cutaway perspective view of components of the injection molding mold of FIGS. 1-6.

FIG. 12 is a flowchart of an exemplary method for injection molding.

### DETAILED DESCRIPTION OF ILLUSTRATIVE EMBODIMENTS

The following detailed description of illustrative embodiments should be read with reference to the drawings, in which like elements in different drawings are numbered identically. The drawings depict illustrative embodiments and are not intended to limit the scope of the invention.

Rather, the present invention is defined solely by the claims.

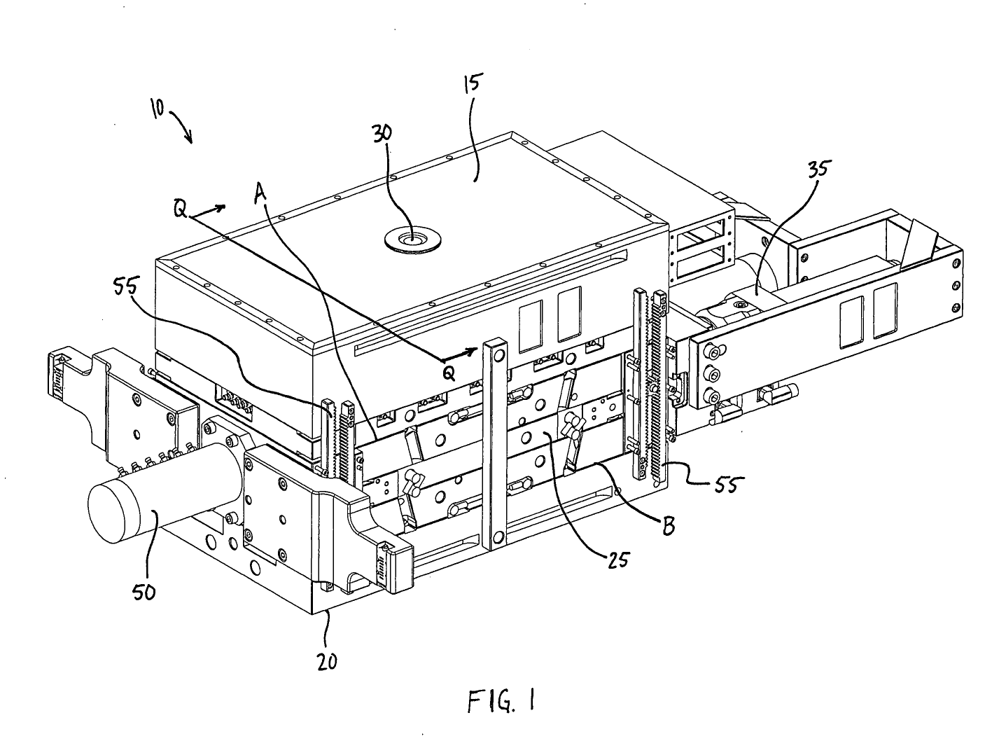

Some embodiments of the invention include the features shown in FIGS. 1-6. FIGS. 1-6 show an exemplary injection molding mold 10. The injection molding mold 10 includes a stationary plate 15 and a movable plate 20. The stationary plate 15 may be configured to be connected to a stationary platen of an injection molding machine. The movable plate 20 may be configured to be connected to a movable platen of an injection molding machine. The injection molding mold 10 includes a turret 25. The stationary plate 15 includes a sprue hole 30 through which resin can flow during an injection molding operation. In some embodiments, the movable plate 20 can include a sprue hole through which resin can flow during an injection molding operation. The injection molding mold 10 includes three actuators 35, 40, 45. Actuator 35 can be a rotary actuator, and actuators 40, 45 can be linear actuators. Each of the actuators 35, 40, 45 can be automatically controlled by a controller. The injection molding mold 10 includes a rotary union 50. The rotary union 50 can allow fluid to flow into a rotating element.

The injection molding mold 10 of FIGS. 1-6 can be operable to open and close. In the closed position, as shown in FIGS. 1-2 and 6, the turret 25 is sandwiched between the stationary plate 15 and the movable plate 20. In the closed position, a quantity of resin can be injected into the mold(s) through the sprue hole(s).

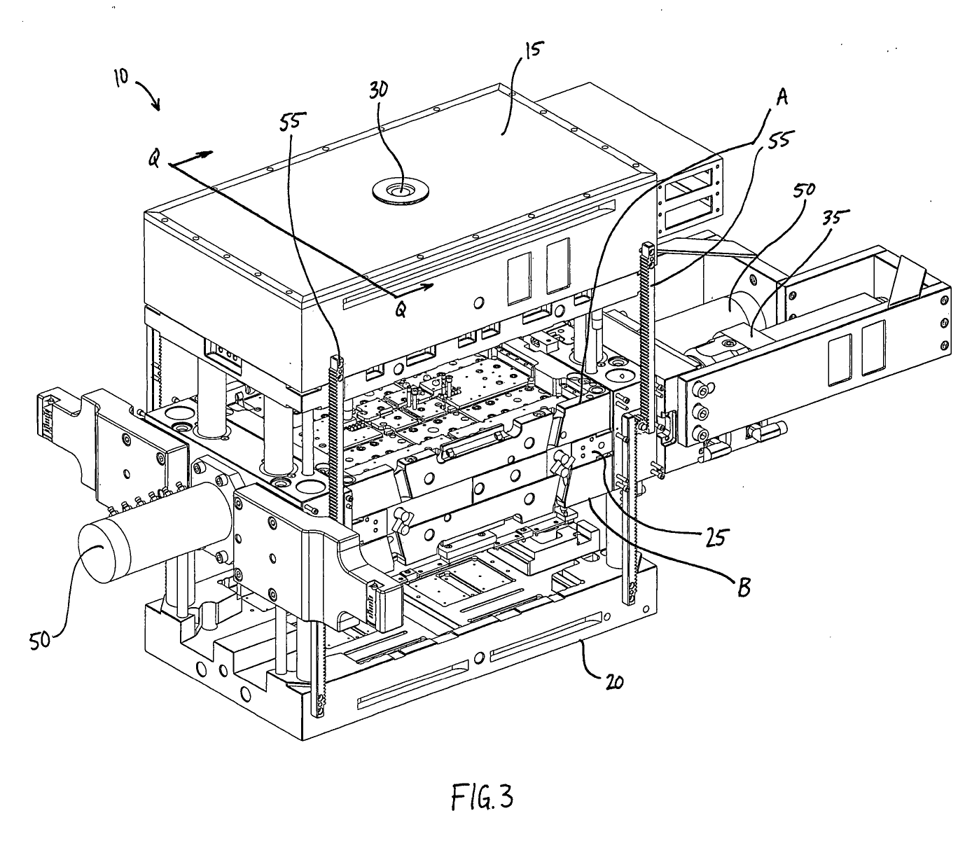

FIGS. 3-5 illustrate the injection molding mold 10 in open positions. In the open position, the stationary plate 15 and the movable plate 20 are spaced apart from the turret 25. An actuator on an injection molding machine to which the injection molding mold 10 might be attached causes the injection molding mold 10 to open and close. As the injection molding machine's movable platen pulls the movable plate 20 away from the turret 25, the turret 25 pulls away from the stationary plate 15. In the embodiment of FIGS. 1-6, a harmonic linkage 55 may ensure proper spacing of the movable plate 20, the turret 25, and the stationary plate 15.

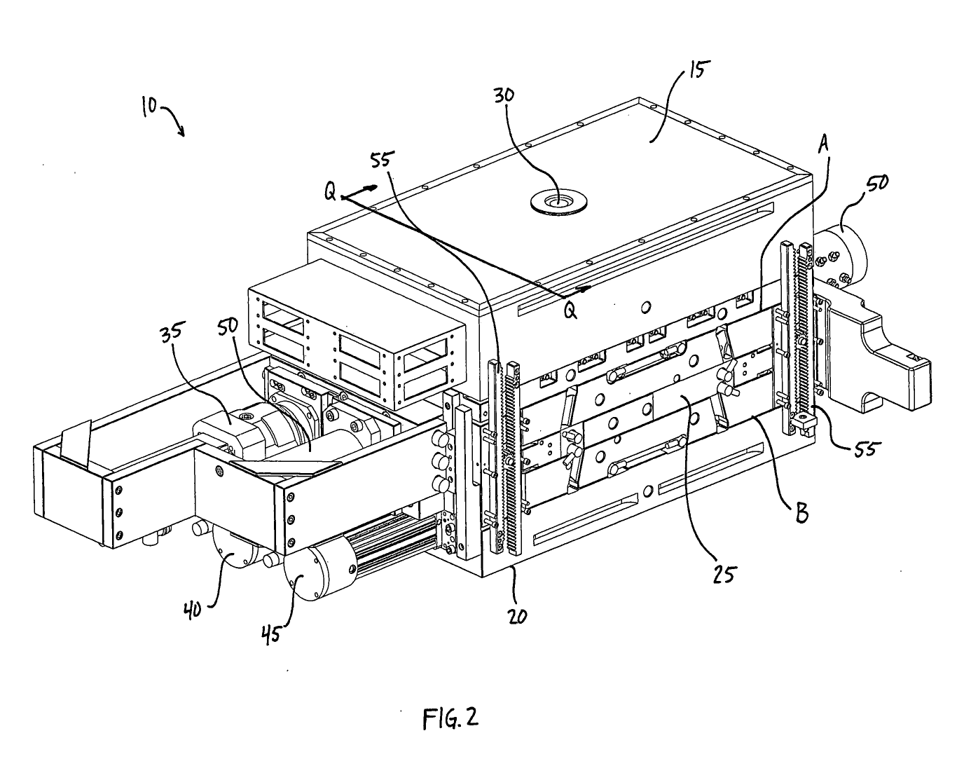

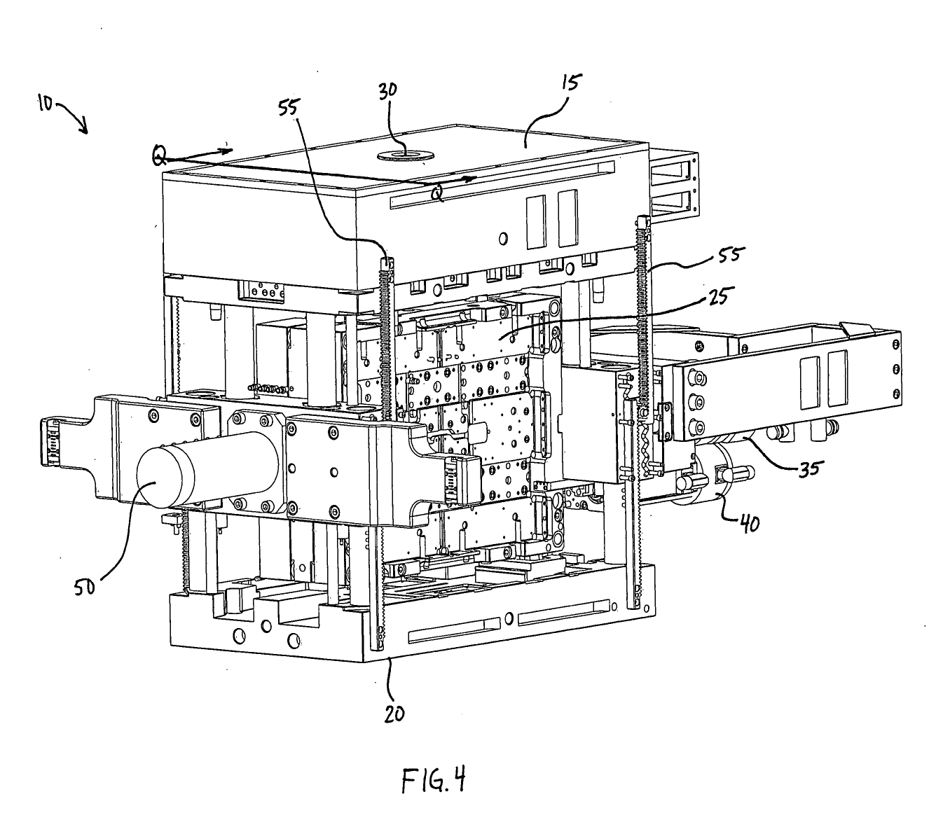

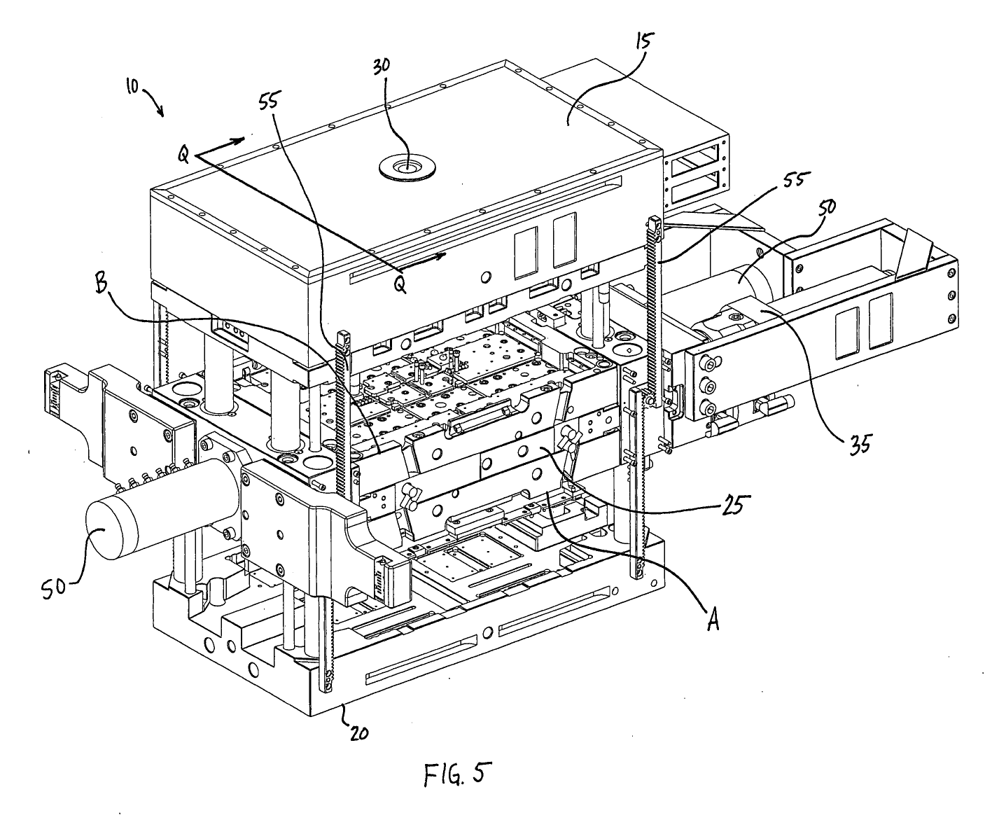

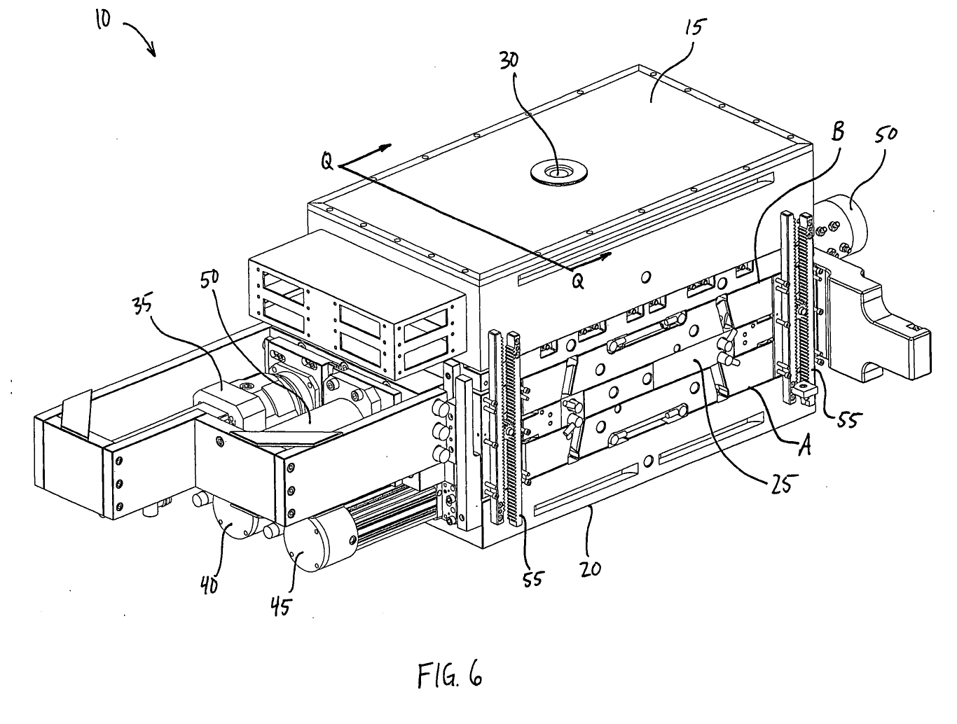

FIG. 4 illustrates how the turret 25 is operable to rotate when the injection molding mold 10 is the open position. An actuator 35 can cause the turret 25 to rotate. The actuator 35 can be any suitable type of rotary actuator (e.g., servo, hydraulic, mechanical, etc.). The actuator 35 can be controlled by a controller. FIG. 5 shows the injection molding mold 10 still in the open position with the turret 25 having been rotated 1800. FIG. 6 shows the injection molding mold 10 returned to the closed position. The difference between FIGS. 1-2 and FIG. 6 is that in FIGS. 1-2, side A of the turret 25 is proximate the stationary plate 15, whereas in FIG. 6, side A of the turret 25 is proximate the movable plate 20.

Many injection molding mold features may supplement and/or replace those discussed in connection with FIGS. 1-6. For example, although the injection molding mold shown in FIGS. 1-6 includes two turret faces, in some embodiments, the turret has a greater number of faces, such as four faces. In such embodiments, an injection molding mold with a four-faced turret can comprise four processing stations-one for each face of the turret. For example, a quantity of resin can be injected at the first processing station, while overmolding is done at the second station, decorating/labeling is done at the third station, and cooling/ejection is done at the fourth station. In such injection molding molds, the turret can rotate through each of the processing stations to produce the desired parts. In some embodiments, the injection molding mold includes a transfer mechanism to transfer parts from a first location in the injection molding mold to a second location in the injection molding mold. In some embodiments, the turret can hold both a fixed mold component and a movable mold component, which, together with a slide, make up a mold cavity. In such embodiments, the movable mold component may be movable relative to the fixed mold component independently of the movement of the injection molding machine's movable platen. Many other configurations are possible.

In some injection molding applications, slides are used. Slides often include a slide block and a mold component that is held by the slide block. The slide mold components, along with mold components such as cavities and cores, combine to form mold cavities in which parts can be injection molded. Slide blocks typically move their mold components in a direction that is different from the direction that the movable plate 20 moves relative to the stationary plate 15. In many instances, the direction of the slide movement is perpendicular to that of the movable plate 20, though such a relationship between the directions is not necessary. In other words, if cavities and cores make up the front and back of mold cavities, slide mold components can play a role in forming the sides of mold cavities. Often, slides are used when parts require undercuts (e.g., threads, holes on the side of the part, latch features, etc.).

In injection molding, throughput can be critical. Because parts are typically molded in high volumes, it is often desirable to minimize the amount of time spent molding each part. At the same time, however, parts often need to remain in the injection molding mold for a duration that is long enough to allow the resin to cool and harden into the finished part. One way to address these conflicting factors—the desire to increase speed and the necessity of allowing the part to cool sufficiently—is to perform other functions while parts are cooling.

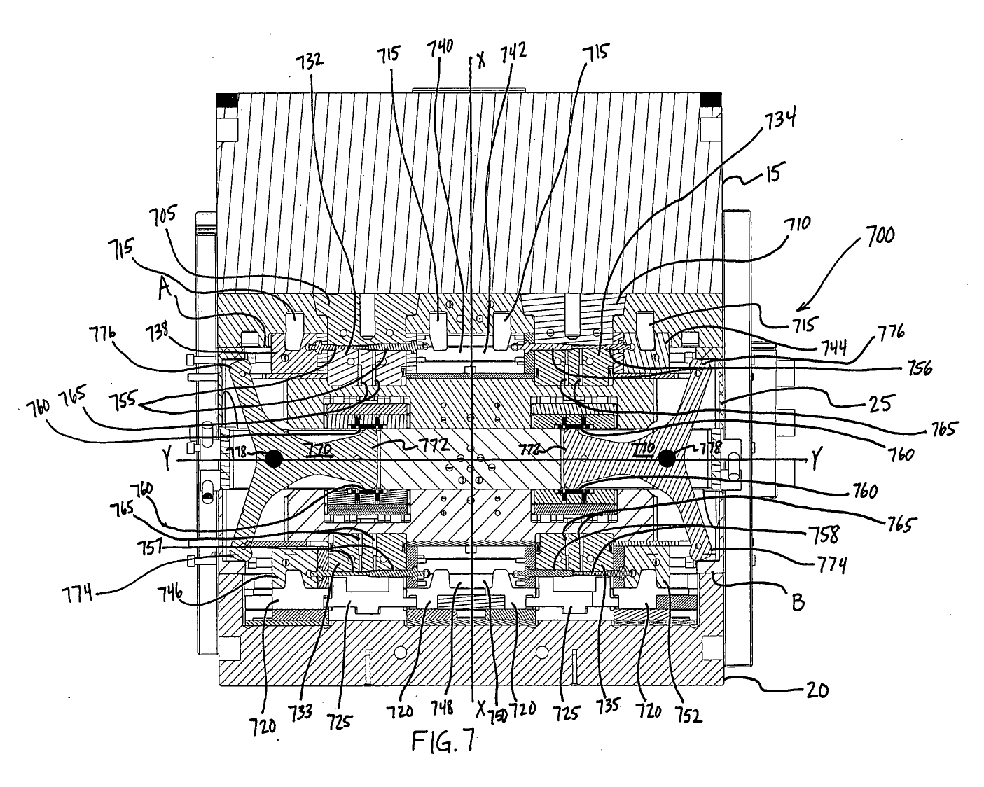

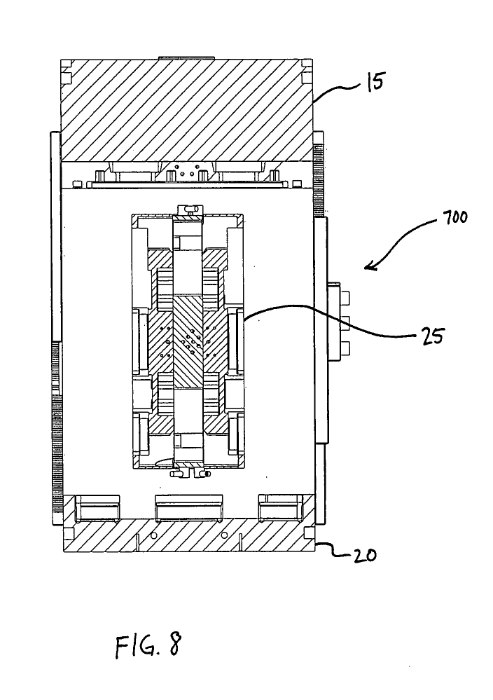

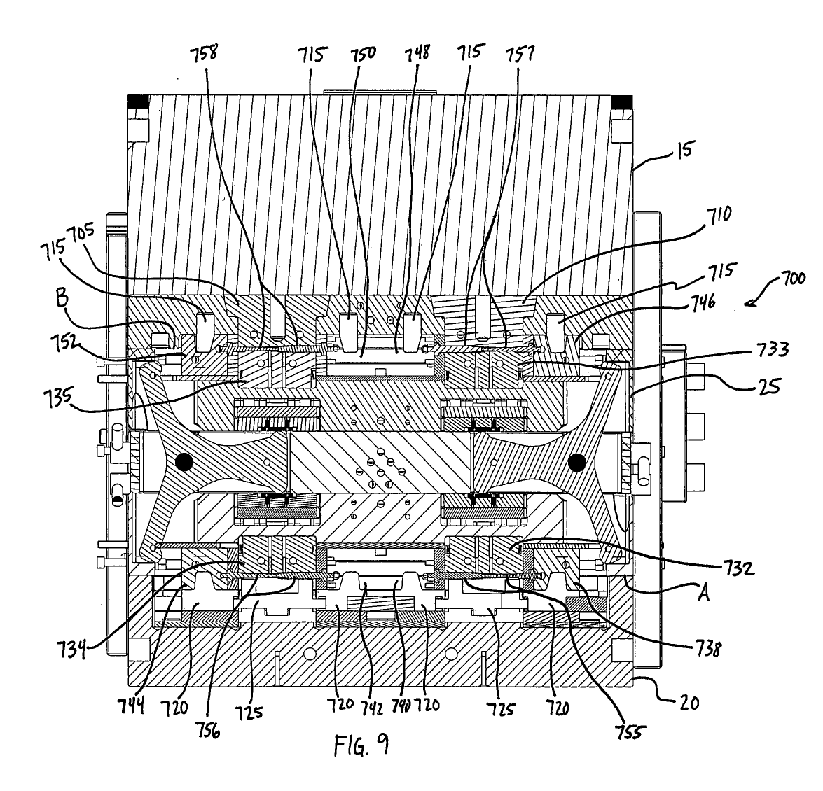

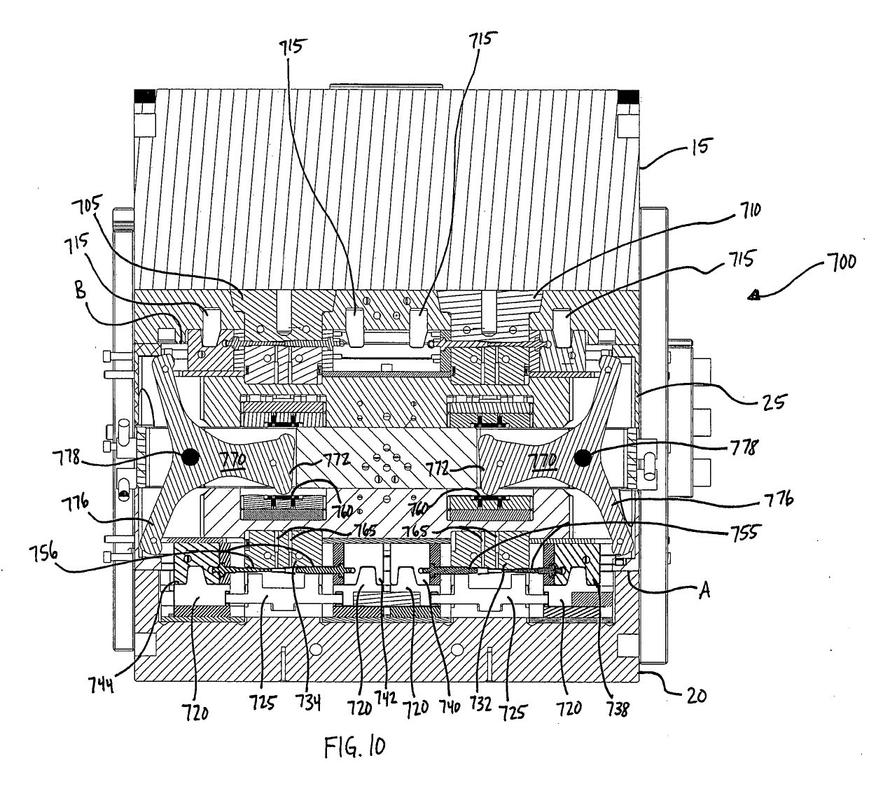

Some embodiments of the invention include the features shown in FIGS. 7-10. FIGS. 7-10 show close-up views of cross-section Q-Q of the injection molding mold of FIGS. 1-6. FIGS. 7-10 show an exemplary slide-eject mechanism 700. FIG. 7 shows the injection molding mold in a first closed position in which side A of the turret 25 is adjacent the stationary plate 15 and side B of the turret 25 is adjacent the movable plate 20. FIG. 8 shows the injection molding mold in an open position with the turret 25 rotating about its axis of rotation. FIG. 9 shows the injection molding mold in a second closed position, the turret 25 having rotated so that side B of the turret 25 is adjacent the stationary plate 15 and side A of the turret 25 is adjacent the movable plate 20. FIG. 10 shows the slide eject mechanism 700 of the injection molding mold in the process of ejecting previously molded parts.

FIGS. 7-10 show several components that are coupled to the stationary plate 15 and several components that are coupled to the movable plate 20. Two mold components 705, 710 and four stationary members 715 are coupled to the stationary plate 15. The mold components 705, 710 can be, e.g., cavities, cores, etc. Four slide engagement blocks 720 and two slide drivers 725 are coupled to the movable plate 20. When the injection molding mold is in the open position, mold components 705, 710 and the stationary members 715 remain with the stationary plate 15, and the slide engagement blocks 720 and the slide drivers 725 remain with the movable plate 20.

FIGS. 7-10 show several components that are coupled to the turret 25. The components of the turret 25 are arranged in a generally symmetrical fashion about both axis of symmetry X-X and axis of symmetry Y-Y. That is, referring to FIG. 7, the turret components positioned above axis of symmetry X-X have corresponding components below axis of symmetry X-X, and the turret components positioned to the left of axis of symmetry Y-Y have corresponding components to the right of axis of symmetry Y-Y. Four mold components 732, 733, 734, 735 are coupled to the turret 25. The mold components 732, 733, 734, 735 can be, e.g., cavities, cores, etc. Eight slide blocks 738, 740, 742, 744, 746, 748, 750, 752 are coupled to the turret 25. Each of the slide blocks 738, 740, 742, 744, 746, 748, 750, 752 holds a core pin 755, 756, 757, 758. Equipment for ejecting finished parts-ejector plates 760 and ejector pins 765-is coupled to the turret 25. A rocker 770 having three arms 772, 774, 776 is configured to rotate about a pivot 778 that is coupled to the turret 25.

Many injection molding mold features may supplement and/or replace those discussed in connection with FIGS. 7-10. For example, each cross-section can comprise a greater or lesser number of parts (e.g., six or eight parts). Some embodiments may not include a turret. In such embodiments, a quantity of resin can be injected into a mold cavity composed partly of slide mold components, the resin can be allowed to cool, and the slide-eject mechanism can open the slides at substantially the same time as it ejects the finished parts according to any of the processes discussed herein. In such embodiments, the rockers can have two arms. In some embodiments, the components of the turret are arranged in a generally symmetrical fashion about only one axis of symmetry. In some embodiments, the components of the turret are not arranged in a generally symmetrical fashion about any axis of symmetry. In some embodiments, equipment for ejecting finished parts can include a stripper plate.

In use, the injection molding mold can be moved into a closed position (as shown in FIG. 7). In the closed position, the stationary members 715 that are coupled to the stationary plate 15 can mate with slide blocks 738, 740, 742, 744 that are coupled to the turret 25. Also in the closed position, slide blocks 746, 748, 750, 752 that are coupled to the turret 25 can mate with the slide engagement blocks 720 that are coupled to the movable plate 20.

With the injection molding mold in the closed position, a first mold cavity can be formed by mold component 705, mold component 732, and core pins 755, and a second mold cavity can be formed by mold component 710, mold component 734, and core pins 756. Resin can be injected into the two mold cavities to create two parts. The injection molding mold of FIGS. 7-10 is configured to mold female luers. But, of course, many other types of parts can be molded in other embodiments. Examples of such other parts include cylindrical medical components (e.g., luers, y-sites, connectors, check valves, etc.), pen caps, barrels, plumbing components, etc.

After the resin has cooled sufficiently, the injection molding mold can move to an open position. To open the injection molding mold, the resin should be cool enough to open the injection molding mold, though it need not yet be cool enough to eject the part. As shown in FIG. 8, the turret 25 (and corresponding components) can move away from the stationary plate 15 (and corresponding components), and the movable plate 20 (and corresponding components) can move away from the turret 25 (and corresponding components). The turret can rotate 1800 about its axis of rotation. During this process, the slide blocks 744, 742, 740, 738 can remain closed.

The injection molding mold can then move back into the closed position (as shown in FIG. 9). At this time, however, the turret face that was formerly aligned with the stationary plate 15 can now be aligned with the movable plate 20 and vice versa. Thus, stationary members 715 can mate with slide blocks 752, 750, 748, 746, and the slide engagement blocks 720 can mate with slide blocks 744, 742, 740, 738.

The parts that had previously been molded can now be positioned adjacent the movable plate 20. Those parts can remain in contact with mold components 732, 734 and the core pins 755, 756, respectively. But the parts can be otherwise exposed. That is, the movable plate 20 of FIGS. 7-10 need not include mold components that correspond to the stationary plate's mold components 705, 710. In some embodiments, the previously molded parts simply continue to cool proximate the movable plate 20. In some embodiments, the previously molded parts are further processed (e.g., overmolded, labeled, decorated, transferred from one location to another, etc.).

In this orientation, two new mold cavities can be formed-one by mold component 705, mold component 735, and core pins 758, and the other by mold component 710, mold component 733, and core pins 757. Resin can then be injected into the new mold cavities to create two more parts. The new parts cool long enough to allow the injection molding mold to be opened (though they need not cool as long as is necessary for ejection).

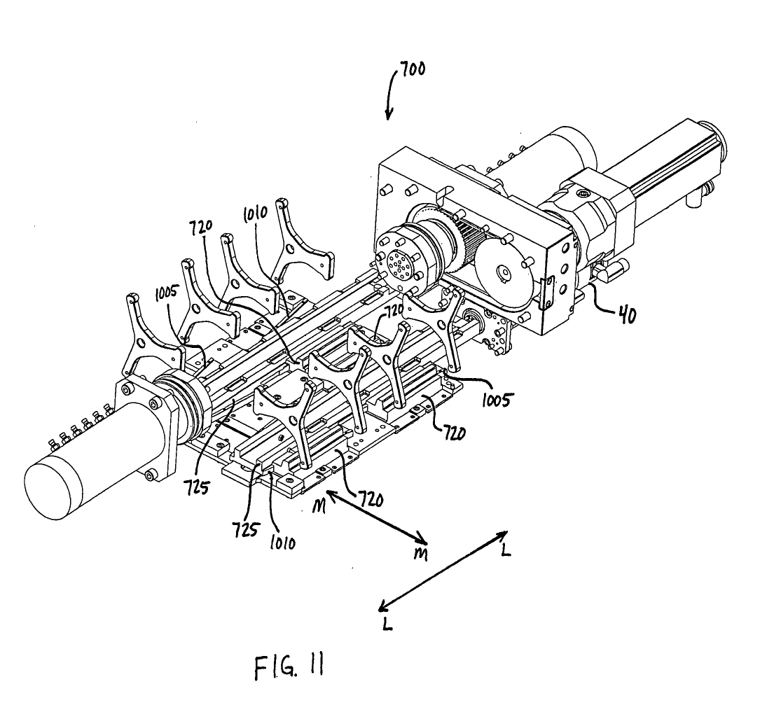

At a predetermined time, (e.g., just before the injection molding mold moves back to the open position, just after the injection molding mold moves back to the open position, etc.), the slide-eject mechanism 700 can eject the previously molded parts. FIG. 10 shows slide-eject mechanism of the injection molding mold in the process of ejecting the previously molded parts. Ejection can occur while the injection molding mold is in either the open position or the closed position. The two pairs of slide engagement blocks 720 can move apart from each other, thereby causing the slide blocks 744, 742, and 740, 738, and the respective core pins 756, 755, to move apart from each other. One cause of the slide engagement blocks' 720 movement is discussed in detail in connection with FIG. 11. Referring again to FIG. 10, as the slide engagement blocks 720 move apart from each other, the outer slide blocks 744, 738 can press against arms 776 of the rockers 770. As those slide blocks 744, 738 continue to press outwardly against arms 776, the rockers 770 can rotate about pivot 778, thereby causing arm 772 of the rockers 770 to press against the respective ejector plates 760. Those ejector plates 760 can then activate the corresponding ejector pins 765, which can push the part away from mold components 734, 732. In this way, the slide-eject mechanism 700 can both withdraw the core pins 756, 755 from the mold cavities and eject finished parts by simply moving the slide engagement blocks 720 outwardly. In some embodiments, the slide-eject mechanism 700 can perform both functions simultaneously. In some embodiments, the slide-eject mechanism's 700 withdrawal of the core pins 756, 755 can cause the ejection of the finished parts.

Moving the slide engagement blocks 720 outwardly to withdraw the core pins 756, 755 from the mold cavities and to eject finished parts provides several advantages. For example, in typical applications, the injection molding machine includes an ejection actuator to trigger ejection of finished parts. But in such embodiments, the parts are ejected toward the injection molding machine's stationary platen. In injection molding molds that use turrets, ejecting parts away from the turret rather than into it is desirable. Thus, using some of the ejection actuators discussed herein allows ejection of finished parts away from the turret. Moreover, making use of the mechanical movement of the slide blocks 744, 742, 740, 738 to eject parts can improve the efficiency of the injection molding mold.

After the previously molded parts are ejected, the slide-eject mechanism 700 can prepare the injection molding mold to perform the process again. The slide engagement blocks 720 can move back to their original positions, thereby causing the rockers 770 to rotate about pivot 778 back to their original positions and the ejection equipment to move back to its original positions. The injection molding mold can move to the open position, the turret 25 can rotate, the injection molding mold can move back to the closed position, and the process can begin again.

Some embodiments of the invention include the features shown in FIG. 11. FIG. 11 shows a cut-away view of the injection molding mold 10 of FIGS. 1-6. The injection molding mold 10 shown herein can perform injection molding processes on up to 64 parts at the same time—32 on each face of the turret. Of course, other configurations are possible. For example, the injection molding mold can perform injection molding processes on a greater or lesser number of parts. Any suitable number of parts is possible.

FIG. 11 shows components of the slide-eject mechanism 700 that contribute to moving the slide engagement blocks 720 outwardly, and thus to withdrawing core pins and ejecting finished parts.

Each slide engagement block 720 (only four of which are shown, though this embodiment would include eight) is coupled to a slide driver 725. The slide drivers 725 include rails 1005 along which the slide engagement blocks 720 are configured to travel. The slide drivers 725 can be moved by actuators 40, 45 along a line of travel L-L. The actuators 40, 45 can be any suitable type of linear actuator (e.g., pneumatic, servo, hydraulic, etc.). A controller can control the movement of the actuators 40, 45. In some embodiments, the actuators 40, 45 are separate from the turret and do not rotate with the turret. In such embodiments, the turret is rotatable relative to the actuators 40, 45. As the slide drivers 725 move in the L-L direction, the tapered surfaces 1010 of the slide drivers 725 cause the slide engagement blocks 720 to move along a line of travel M-M. In the embodiment of FIG. 11, line of travel M-M is generally perpendicular to line of travel L-L, but the angle between line of travel M-M and line of travel L-L can be any suitable angle. Thus, the actuators' 40, 45 moving back and forth in the L-L direction triggers a chain of events (discussed in connection with FIGS. 7-10) that ultimately withdraws the core pins from the mold cavities and ejects finished parts.

The slide-eject mechanism 700 of FIGS. 7-10 can be configured in a variety of ways. For example, some embodiments implement a greater or lesser number of slide drivers (e.g., one or three). In some embodiments, a single actuator can move more than one slide driver. For example, one actuator can move a bar, which then moves multiple slide drivers. In some embodiments, the slide drivers need not be actuated at the same time. For example, some parts may need to cool longer than others, so the slide drivers associated with those parts may be actuated later in the molding cycle. In some embodiments, the slide engagement blocks can be inwardly biased against the slide drivers rather than riding along slide driver rails. In such embodiments, the movement of the slide drivers can accomplish slide engagement block movement that is substantially similar to embodiments that incorporate slide driver rails. Although the slide drivers 725 in the embodiment of FIG. 11 are wedge drivers, many other types of slide drivers are possible. For example, racks, worm gear mechanisms, and other suitable mechanisms for transferring force from one direction to another are possible.

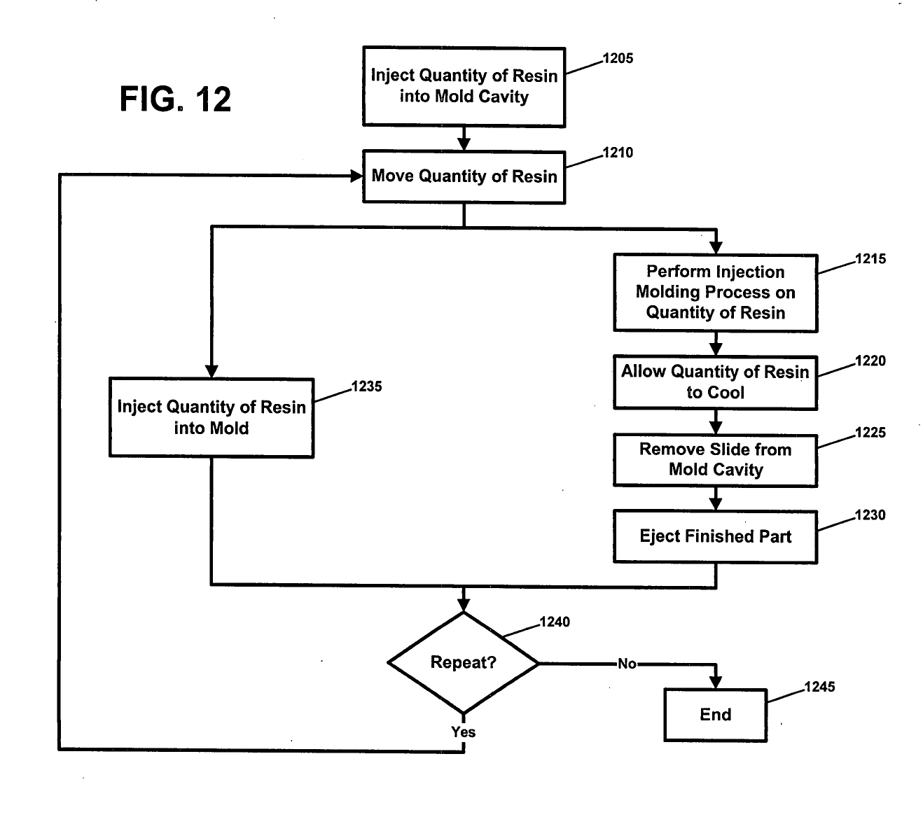

Some embodiments of the invention include the features shown in FIG. 12. FIG. 12 shows an exemplary injection molding method. A quantity of resin can be injected into a mold cavity (1205). The mold cavity can include a slide. The quantity of resin can be moved (1210). In some embodiments, moving the quantity of resin can involve rotating a turret from an injection processing station to an ejection processing station.

After the quantity of resin is moved (1210), two operations can proceed concurrently. The first involves further processing of the aforementioned quantity of resin. An injection molding process can be performed on the quantity of resin (1215). Examples of injection molding processes include over molding, labeling, decorating, transferring, and combinations thereof. The quantity of resin can be allowed to cool (1220), as is discussed elsewhere herein. After the quantity of resin has cooled and become a finished part, the slide can be removed from the mold cavity (1225). The finished part can be ejected from the mold cavity (1230). In some embodiments, removing the slide from the mold cavity (1225) can cause the finished part to be ejected from the mold cavity (1230).

The second operation involves a second quantity of resin. While the injection molding process is being performed on the quantity of resin (1220), the slide is removed (1225), and the finished part is ejected (1230), a second quantity of resin can be injected into a second mold cavity (1235). The second quantity of resin can be injected into the second mold cavity (1235) at the same location that the previously mentioned quantity of resin was injected into the previously mentioned mold cavity (1205). Performing these two operations concurrently can save a substantial amount of time, which can significantly improve injection molding throughput.

When the two aforementioned operations are completed, a determination can be made whether to continue the exemplary injection molding method (1240). If it is determined that the method should be continued, the second quantity of resin can be moved and the same or similar way that the first quantity of resin was moved (1210). If it is determined that the method should not be continued, the method can come to an and (1245).

The method provided in FIG. 12 is presented for purposes of illustration only. One skilled in the art will appreciate that other methods may be implemented in connection with the present invention. Moreover, the order of steps provided in the method shown in FIG. 12 is provided for purposes of illustration only. Any order that achieves the desired functionality may be implemented. Any of the functionality discussed anywhere in this disclosure may be implemented in the method shown in FIG. 12.

Certain embodiments of the slide-ejector actuator are disclosed. One skilled in the art will appreciate that the present invention can be practiced with embodiments other than those disclosed. The disclosed embodiments are presented for purposes of illustration and not limitation, and the present invention is limited only by the claims that follow.

What is claimed is:

1. An injection molding mold for use in injection molding applications, comprising:
first and second mold plates, the first mold plate being configured to be connected to a stationary platen of an injection molding machine and the second mold plate being configured to be connected to a movable platen of an injection molding machine;
a mold cavity that comprises a slide;
a slide-eject mechanism configured to eject a finished part from the mold cavity by removing the slide from the mold cavity; and
an actuator coupled to one of the mold plates, the actuator being configured to actuate the slide-eject mechanism.

2. The injection molding mold of claim 1, wherein (a) the slide-eject mechanism includes a slide driver, (b) the actuator is configured to move the slide driver in a first direction, and (c) the slide driver is configured to remove the slide from the mold cavity by moving the slide in a second direction that differs from the first direction.

3. The injection molding mold of claim 2, wherein the second direction is substantially perpendicular to the first direction.

4. The injection molding mold of claim 2, wherein the slide-eject mechanism includes a rocker and ejection equipment, the rocker being configured to trigger the ejection equipment in response to being contacted by the slide.

5. The injection molding mold of claim 1, further comprising a rotatable turret positioned between, and coupled to, the first and second mold plates, wherein a portion of the mold cavity is coupled to the rotatable turret.

6. The injection molding mold of claim 5, wherein the rotatable turret comprises an injection processing station on a first turret face and an ejection processing station on a second turret face, and wherein the rotatable turret is configured to allow a first part to be formed at the injection processing station and ejected at the ejection processing station.

7. The injection molding mold of claim 1, wherein the slide-eject mechanism is configured to eject a finished part when the injection molding mold is in a closed position.

8. The injection molding mold of claim 5, wherein the slide-eject mechanism comprises:
a slide driver coupled to one of the mold plates, the slide driver being movable by the actuator in a first direction;
a slide engagement block coupled to the one of the mold plates, the slide engagement block being movable by the slide driver in a second direction that differs from the first direction and being configured to engage the slide and move the slide in the second direction;
ejection equipment coupled to the rotatable turret, the ejection equipment being configured to eject the finished part from the mold cavity; and
a rocker coupled to the rotatable turret, the rocker being configured to make use of energy from movement of the slide in the second direction by triggering the ejection equipment to eject the finished part from the mold cavity.

9. The injection molding mold of claim 5, wherein the rotatable turret is rotatable relative to the actuator.

10. An injection molding mold for use in injection molding applications, comprising:
first and second mold plates, the first mold plate being configured to be connected to a stationary platen of an injection molding machine and the second mold plate being configured to be connected to a movable platen of an injection molding machine;
a rotatable turret having a mold cavity that comprises a slide;
slide-eject means for removing the slide from the mold cavity or ejecting a finished part from the mold cavity; and
an actuator coupled to one of the mold plates, the actuator being configured to actuate the slide-eject means, wherein the rotatable turret is rotatable relative to the actuator.

11. The injection molding mold of claim 10, wherein (a) the slide-eject means comprises a slide driver, (b) the actuator is configured to move the slide driver in a first direction, and (c) the slide driver is configured to remove the slide from the mold cavity by moving the slide in a second direction that differs from the first direction.

12. The injection molding mold of claim 11, wherein the slide-eject means further comprises a rocker and ejection equipment, the rocker being configured to trigger the ejection equipment in response to being contacted by the slide.

13. The injection molding mold of claim 10, wherein the slide-eject means comprises:
a slide driver coupled to one of the mold plates, the slide driver being movable by the actuator in a first direction;
a slide engagement block coupled to the one of the mold plates, the slide engagement block being movable by the slide driver in a second direction that is substantially perpendicular to the first direction and being configured to engage the slide and move the slide in the second direction;
ejection equipment coupled to the rotatable turret, the ejection equipment being configured to eject the finished part from the mold cavity; and
a rocker coupled to the rotatable turret, the rocker being configured to transfer energy from movement of the slide in the second direction to the ejection equipment, thereby enabling the ejection equipment to eject the finished part from the mold cavity at substantially the same time as the slide is removed from the mold cavity.

14. The injection molding mold of claim 10, wherein the rotatable turret has exactly two turret faces.

15. An injection molding method, comprising:
injecting a first quantity of resin into a first mold cavity, the first mold cavity comprising a first slide;
allowing the first quantity of resin to cool, thereby creating a first finished part;
removing the first slide from the first mold cavity; and
ejecting the first finished part as a result of removing the first slide from the first mold cavity.

16. The injection molding method of claim 15, further comprising moving the first quantity of resin and the first slide from an injection processing station to an ejection processing station.

17. The injection molding method of claim 16, further comprising injecting a second quantity of resin into a second mold cavity that comprises a second slide at the injection processing station while the first quantity of resin is cooling at the ejection processing station.

18. The injection molding method of claim 15, further comprising performing an injection molding process on the first quantity of resin, the injection molding process being selected from a group consisting of: overmolding, labeling, decorating, transferring, and combinations thereof.

19. The injection molding method of claim 15, wherein removing the first slide from the first mold cavity comprises actuating a slide driver to move in a first direction, thereby causing the first slide to move out of the first mold cavity in a second direction that differs from the first direction.

20. The injection molding method of claim 15, wherein ejecting the first finished part comprises causing a rocker to trigger ejection equipment in response to being contacted by the first slide.

21. A slide-eject mechanism, comprising:
means for withdrawing a slide from a mold cavity; and
means for ejecting a part from the mold cavity in response to removing the slide from the mold cavity.
